(19) United States
(12) Patent Application Publication
(10) Pub. No.: US 2006/0279861 A1
(43) Pub. Date: Dec. 14, 2006

(54) Saftey mirror

(76) Inventor: Martin W. Vanderhoek, Surrey (GB)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 10/568,078

(22) PCT Filed: Jul. 23, 2004
(86) PCT No.: PCT/CA04/01085

§ 371 Date: Aug. 10, 2006

(30) Foreign Application Priority Data
Aug. 11, 2003 (US) 60493814

(51) Int. Cl. G02B 5/08

(52) U.S. Cl. 359/843

(57) ABSTRACT

A safety mirror for a vehicle having a side mirror, the safety mirror comprising a reflective surface attached to a rear portion of the vehicle by an attachment mechanism, the reflective surface facing toward the side mirror such that a driver sees images from an area adjacent a front portion of the vehicle by means of reflections in the safety mirror and the side mirror.

### TECHNICAL FIELD

The invention relates to safety mirrors, and particularly to mirrors for viewing blind spots of trucks.

### BACKGROUND

A motor vehicle generally has a number of mirrors to allow the driver to see an increased portion of the vehicle and the surrounding area. However, even with mirrors there typically exist ‘blind spots’, that is, areas which the driver can not see into without shifting positions. The area covered by these blind spots tend to increase along with the size of the vehicle. As such, blind spots can be especially dangerous for large vehicles such as tractor trailer trucks or the like.

On large motor vehicles such as tractor trailer trucks or the like, there are typically blind spots which exist adjacent the forward portion of the cab of a tractor trailer truck. The blind spot on the passenger side of the cab is particularly problematic, as the driver generally will not be able to get close enough to the passenger side window to look down into that blind spot. As shown in prior art FIG. 1, truck 10 has a standard side mirror 12 attached on the passenger side of cab 14. Driver 16 is unable to see a small car 18 immediately adjacent to the passenger side of cab 14, even with side mirror 12.

Summers (U.S. Pat. No. 5,479,297) discloses one possible solution to the problem of the blind spot illustrated in FIG. 1. Summers provides a mirror assembly for mounting on a forward portion of the passenger side of a tractor trailer truck or the like. However, the mirror assembly of Summers is large and unwieldy, and some truck drivers are reluctant to install such a contraption on their trucks. Furthermore, the mirror assembly of Summers may exacerbate the problem of the blind spot just in front of the assembly, due to its size.

There exists a need for improved apparatus and methods for eliminating blind spots on motor vehicles, particularly on large motor vehicles such as tractor trailer trucks.

### SUMMARY OF INVENTION

The invention provides a safety mirror for a vehicle having a side mirror, the safety mirror comprising a reflective surface attached to a rear portion of the vehicle by an attachment mechanism, the reflective surface facing toward the side mirror such that a driver sees images from an area adjacent a front portion of the vehicle by means of reflections in the safety mirror and the side mirror.

The reflective surface may comprise a convex surface, and the attachment mechanism may comprise a housing which holds the reflective surface. A backup light may be attached to a rearward facing portion of the housing and positioned to direct light rearwardly. A pivotal connection may be provided for attaching the reflective surface to the attachment mechanism.

The attachment mechanism may comprise a backup light positioned to direct light rearwardly, and the reflective surface may be attached to a forward facing portion of the backup light. A pivotal connection may be provided for attaching the reflective surface to the backup light.

### BRIEF DESCRIPTION OF DRAWINGS

In drawings which illustrate non-limiting embodiments of the invention:

FIG. 1 is a side view of a truck and a small car according to the prior art;

FIG. 2 is a side view of a truck and a small car wherein the truck is equipped with a safety mirror according to one embodiment of the invention;

FIG. 3 is a top view of the cab of a truck equipped with a pair of safety mirrors according to another embodiment of the invention;

FIG. 4 is a close up top view of the passenger side safety mirror of FIG. 3;

FIG. 5 is a top view similar to FIG. 4 of a safety mirror according to another embodiment of the invention; and,

FIG. 6 is a top view similar to FIG. 4 of a safety mirror according to another embodiment of the invention.

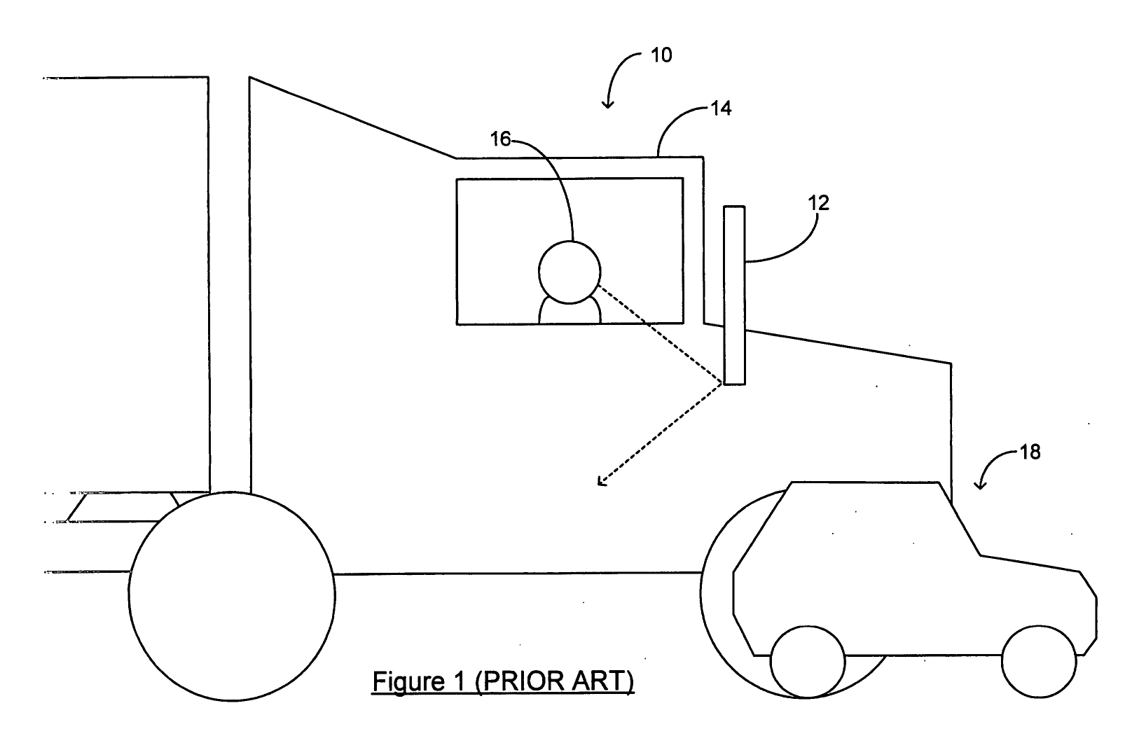

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

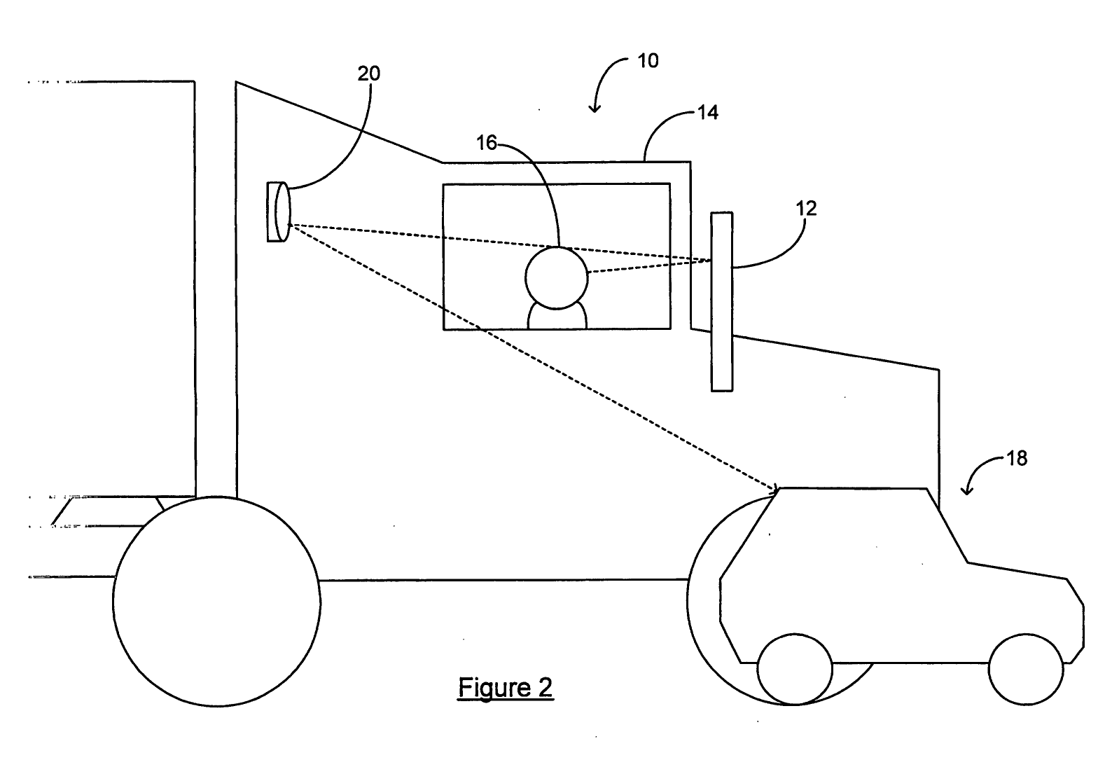

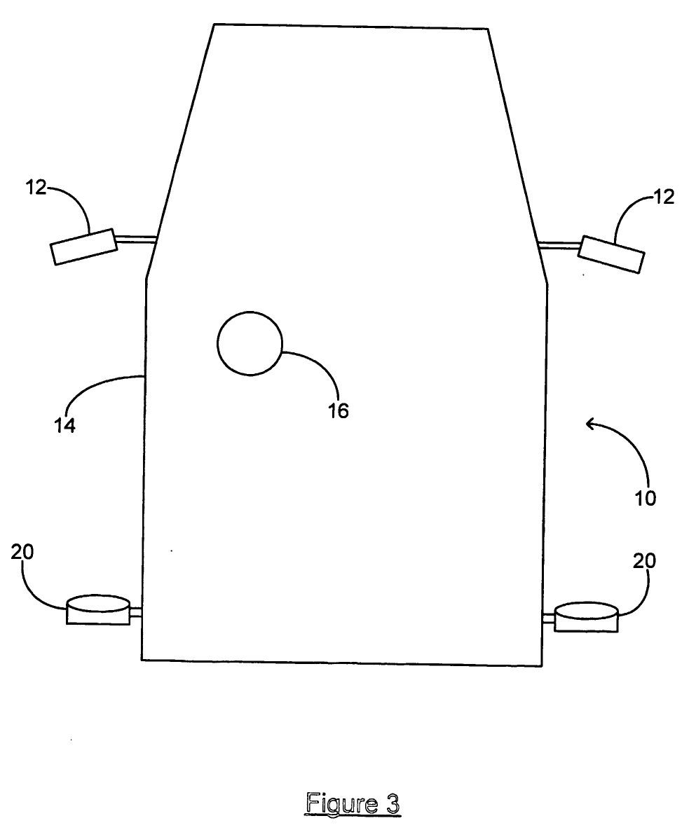

FIG. 2 illustrates truck 10 equipped with a safety mirror 20 according to one embodiment of the invention. Safety mirror 20 is preferably attached to the upper rear portion of cab 14, but safety mirror 20 could also be attached to a lower rear or middle rear portion of cab 14. Driver 16 can look into side mirror 12 and see small car 18 reflected in safety mirror 20. FIG. 2 only shows the passenger side of cab 14, but it is to be understood that another safety mirror 20 could be placed on the driver side of cab 14, as shown in FIG. 3.

FIG. 4 illustrates an embodiment of the invention wherein safety mirror 20 comprises a reflective surface 22 attached to cab 14 by means of attachment mechanism 24. Reflective surface 22 is preferably convex to provide driver 16 with a wide range of reflected images. Reflective surface 22 may be held in a fixed location by attachment mechanism 24, or it may be allowed to pivot slightly to provide adjustability to safety mirror 20. In the embodiment shown in FIG. 4, attachment mechanism 24 comprises arm 26 which is attached to cab 14 at one end. Housing 28 is attached to the opposite end of arm 26 and holds reflective surface 22 therein.

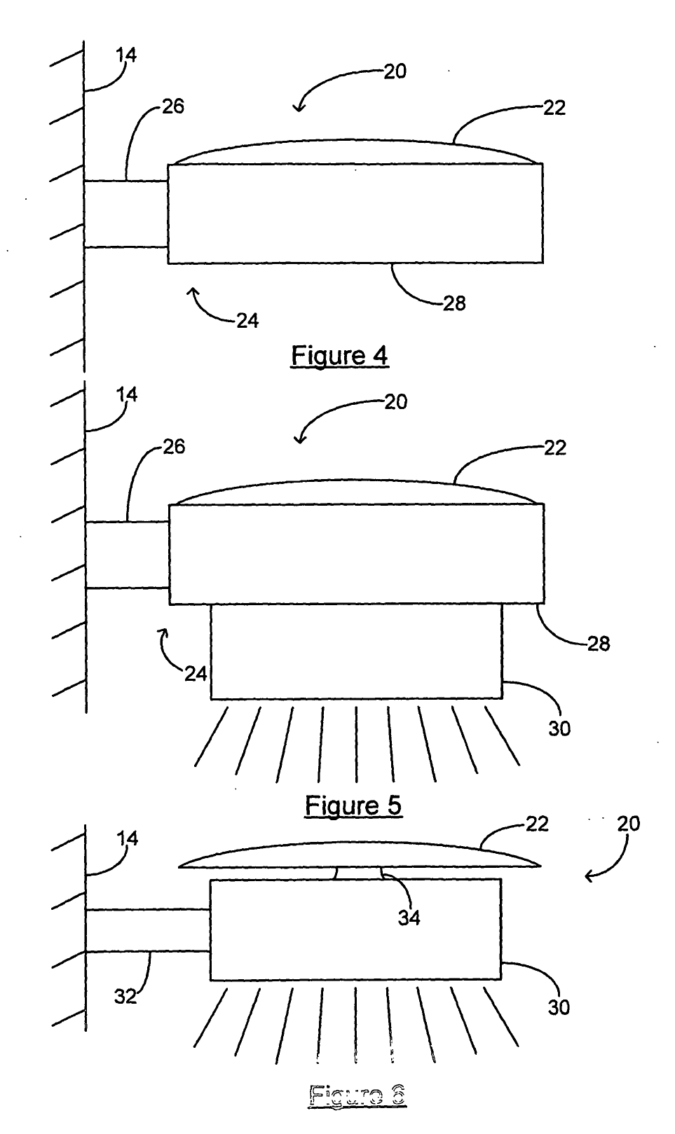

In another embodiment, as shown in FIG. 5, safety mirror 20 comprises a backup light 30 attached to the rear of housing 28. Backup lights are generally provided on the upper rear portions of the cab of a truck, facing backwards, to illuminate the area behind the truck when the truck is in reverse.

In another embodiment, as shown in FIG. 6, safety mirror 20 simply comprises a reflective surface 22 attached to the front of a backup light 30 which is attached to cab 14 by standard mounting means 32. Reflective surface 22 may optionally be attached to backup light 30 by a pivotal connection 34.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A safety mirror for a vehicle having a side mirror, the safety mirror comprising a reflective surface attached to a rear portion of the vehicle by an attachment mechanism, the safety mirror comprising a backup light attached to a rear portion thereof and positioned to direct light rearwardly, the reflective surface facing toward the side mirror such that a driver sees images from an area adjacent a front portion of the vehicle by means of reflections in the safety mirror and the side mirror.

2. A safety mirror according to claim 1 wherein the reflective surface comprises a convex surface.

3. A safety mirror according to claim 1 wherein the attachment mechanism comprises a housing which holds the reflective surface.

4. A safety mirror according to claim 3 wherein the backup light is attached to a rearward facing portion of the housing.

5. A safety mirror according to claim 1 comprising a pivotal connection for attaching the reflective surface to the attachment mechanism.

6. A safety mirror according to claim 1 wherein the attachment mechanism comprises the backup light attached to an upper rear portion of the vehicle, and wherein the reflective surface is attached to a forward facing portion of the backup light.

7. A safety mirror according to claim 6 comprising a pivotal connection for attaching the reflective surface to the backup light.
